(19) United States
(12) Patent Application Publication
(10) Pub. No.: US 2022/0412839 A1
(43) Pub. Date: Dec. 29, 2022

(54) DOUBLE-TABLE VIBRATION TESTING DEVICE

(71) Applicant: Institute of Geology and Geophysics, Chinese Academy of Sciences, Beijing (CN)

(72) Inventors: Zhongxing WANG, Beijing (CN); Renzhong PEI, Beijing (CN); Wenxiu ZHANG, Beijing (CN); Tianxin ZHANG, Beijing (CN); Yongyou YANG, Beijing (CN); Dan ZHAO, Beijing (CN)

(21) Appl. No.: 17/899,312

(22) Filed: Aug. 30, 2022

Related U.S. Application Data
(63) Continuation of application No. PCT/CN2021/137360, filed on Dec. 13, 2021.

(30) Foreign Application Priority Data
Dec. 29, 2020 (CN) 202011590537.X

(51) Int. Cl. G01M 7/02

(52) U.S. Cl. CPC G01M 7/027

(57) ABSTRACT

The present application provides a double-table vibration testing device. The device includes two auxiliary devices and two vibration devices; each auxiliary device includes a lifting apparatus which is provided with a lifting portion; and a sliding member which is assembled on the lifting portion and slides relative to the lifting portion in a longitudinal direction. A drilling tool (an object to be tested) is held by the two auxiliary devices, so that the weight of the drilling tool does not exceed the maximum load-bearing capacity of the vibration devices. Therefore, the vibration devices are not easily damaged, and the drilling tool is not easy to overturn in the vibration testing process.

### CROSS-REFERENCE TO RELATED APPLICATIONS

This application is a bypass continuation application of PCT application no.: PCT/CN2021/137360. This application claims priorities from PCT Application PCT/CN2021/137360, filed Dec. 13, 2021, and from Chinese Patent Application No. 202011590537.X, filed on Dec. 29, 2020, the contents of which are incorporated herein in the entirety by reference.

### TECHNICAL FIELD

The present application relates to the field of downhole tool vibration testing technologies, and more particularly, to a double-table vibration testing device.

### BACKGROUND

At present, an intelligent guided drilling system is a relatively advanced drilling and logging tool in the petroleum field, which, when working underground, encounters a working environment with strong vibration and strong impact. In order to verify the environment and reliability of this system, it is necessary to perform a vibration simulation test through a vibration table in a laboratory environment to verify the environmental adaptability and reliability of an instrument. The commonly used method for a vibration test of a downhole tool is to directly fix an instrument under test on the vibration table through a fixture to perform a vibration test. Since the downhole tool and the vibration table are connected by a ball head and the ball head is of a movable structure with a certain deflection angle, it cannot be guaranteed that the downhole tool is stably fixed on the vibration table after being connected by the fixture and the ball head, resulting in a risk of easy overturning of the downhole tool. In addition, during the vibration test, if a design test condition is greater than a load-bearing capacity of the ball head or the vibration table, the ball head and the vibration table are easily damaged. For a curved downhole tool, it cannot be guaranteed that it is maintained on same horizontal plane as the vibration table, that is, the ball head has a deflection angle, and the ball head and the vibration table are easily damaged during the vibration test.

### SUMMARY

An object of the present application is to provide a double-table vibration testing device that can ensure that a downhole tool is not easily overturned and a vibration device is not easily damaged during a vibration test.

To solve the above problem, embodiments of the present application provide a double-table vibration testing device. The device includes two auxiliary devices and two vibration devices; each auxiliary device includes a lifting apparatus which is provided with a lifting portion; a sliding member which is assembled on the lifting portion and slides relative to the lifting portion in a longitudinal direction; and an elastic member which provides a force for the sliding member to slide upward.

Further, the lifting portion is provided with a guide hole; an axial direction of the guide hole is the longitudinal direction; and the sliding member is assembled in the guide hole and slides relative to the lifting portion in the longitudinal direction.

Further, an inner wall of the guide hole or a surface of the sliding member is provided with a groove, and a ball is arranged in the groove.

Further, the groove is arranged around the axial direction of the guide hole, and disposed in a circumferential direction.

Further, the elastic member is a spring; and the spring sleeves the sliding member and is telescopic in the longitudinal direction.

Further, the sliding member is a sliding rod.

Further, a fixture is arranged on the sliding member and used to clamp a drilling tool.

The above-mentioned technical solution of the present application has the following beneficial technical effects. The drilling tool is held by the two auxiliary devices, so that the weight of the drilling tool does not exceed the maximum load-bearing capacity of the vibration devices. Therefore, the vibration devices are not easily damaged, and the drilling tool is not easy to overturn in the vibration testing process. In addition, an inherent frequency of a system consisting of the auxiliary devices, the drilling tool and the vibration devices can be adjusted by adjusting positions and heights of the two auxiliary devices and the drilling tool, thereby avoiding a resonance frequency during the vibration test.

### BRIEF DESCRIPTION OF THE DRAWINGS

FIG. 1 is a schematic structural diagram of a double-table vibration testing device in an embodiment of the present application;

FIG. 2 is a schematic structural diagram of an auxiliary device in an embodiment of the present application; and

FIG. 3 is a schematic diagram showing a connecting structure of a sliding member, a guide hole and a ball in an embodiment of the present application.

Reference symbols represent the following components:
10—lifting table; 20—limiting frame; 30—sliding rod; 40—holding component; 50—spring; 60—ball; and 70—vibration device.

### DETAILED DESCRIPTION

In order to make the objects, technical solutions and advantages of the present application clearer, the following describes the present application in further detail in conjunction with specific embodiments and with reference to the accompanying drawings. It should be understood that these descriptions are exemplary only and are not intended to limit the scope of the present application. Also, in the following description, the descriptions on well-known structures and techniques are omitted to avoid unnecessarily obscuring the concepts of the present application.

Schematic structural diagrams according to the embodiments of the present application are shown in accompanying drawings. These diagrams are not drawn to scale and some details may have been omitted for clarity. Various regions, shapes, as well as relative sizes and positional relationships between them shown in the drawings are only exemplary, and in practice, may be deviated due to manufacturing tolerances or technical limitations. Those skilled in the art can additionally design regions/layers with different shapes, sizes, and relative positions according to actual needs.

Of course, the described embodiments are merely some embodiments, rather than all embodiments, of the present application. Based on the embodiments of the present application, all other embodiments derived by a person of ordinary skill in the art without creative efforts shall fall within the protection scope of the present application.

In addition, the technical features involved in different embodiments of the present application described below can be combined with each other as long as they do not conflict with each other.

The present application will be described in more detail below with reference to the accompanying drawings. In the respective drawings, the same elements are designated by similar reference symbols. For the sake of clarity, various parts in the drawings have not been drawn to scale.

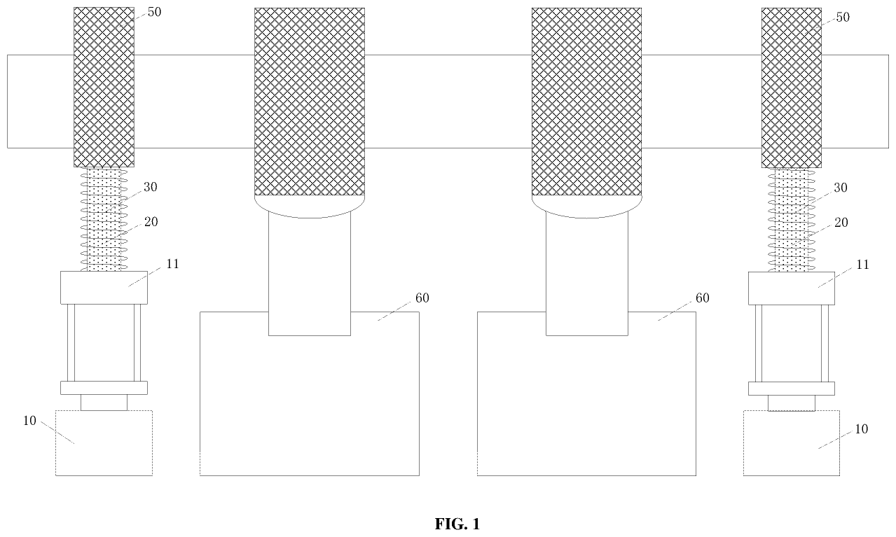

FIG. 1 is a schematic structural diagram of a double-table vibration testing device in an embodiment of the present application.

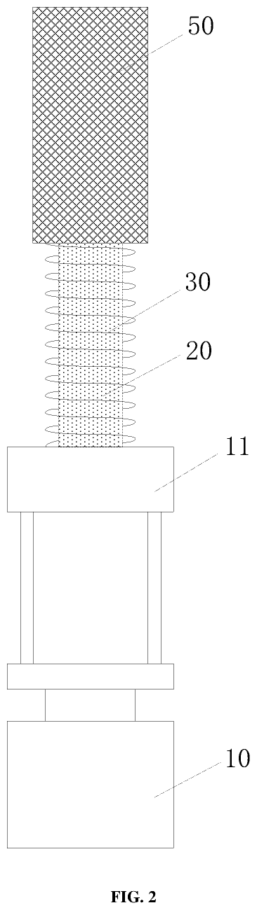

FIG. 2 is a schematic structural diagram of an auxiliary device in an embodiment of the present disclosure.

In the embodiment of the present application, as shown in FIG. 1, a double-table vibration testing device is provided. The device mainly includes two auxiliary devices and two vibration devices 60. As shown in FIG. 2, the auxiliary device mainly includes a lifting apparatus 10, a sliding member 20 and an elastic member 30. The lifting apparatus 10 is provided with a lifting portion. The sliding member 20 is assembled on the lifting portion and slides relative to the lifting portion in a longitudinal direction. The elastic member 30 provides a force for the sliding member 20 to slide upward.

A drilling tool is a slender cylinder with a length of 2-9 m, a diameter of 172-192 mm and a weight of 500-1500 kg. According to test requirements, a full-scale drilling tool vibration test is required.

Specifically, the two auxiliary devices are arranged on a horizontal bottom surface at the same height, respectively located on two opposite sides of the vibration devices 60, and spaced from the vibration devices 60 by equal distances. The vibration devices 60 are located at a certain height, so that the drilling tool is horizontally arranged on the two auxiliary devices and the vibration devices 60. The two auxiliary devices provide an auxiliary support force so that the drilling tool does not exceed the maximum load-bearing capacity of the vibration devices 60.

The lifting device is arranged at a lower portion of the auxiliary device and is provided with a lifting portion (a lifting table) which ascends and descends in a longitudinal direction. The sliding member is slidably connected to the lifting portion. The drilling tool is assembled on the sliding member 20, and the sliding member 20 vibrates synchronously with the vibration of the drilling tool, so that the sliding member 20 slides relative to the lifting portion in the longitudinal direction. The sliding member 20 slides downward as the drilling tool vibrates downward. After the elastic member 30 is compressed to a certain amount of compression, an elastic force of the elastic member 30 releases the two auxiliary devices to balance the force of the drilling tool, so that the drilling tool is not easy to tilt or even overturn during the vibration test.

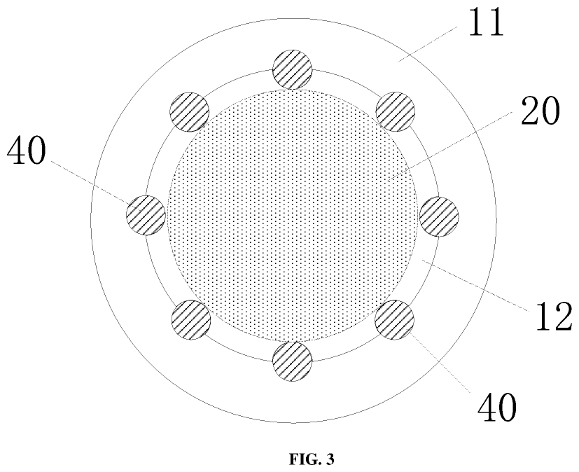

FIG. 3 is a schematic diagram showing a connecting structure of a sliding member, a guide hole and a ball in an embodiment of the present application.

In some embodiments, as shown in FIG. 3, the lifting portion is provided with a guide hole 12; an axial direction of the guide hole 12 is the longitudinal direction; and the sliding member 20 is assembled in the guide hole 12 and slides relative to the lifting portion in the longitudinal direction.

Specifically, a supporting frame may be arranged on the lifting portion and provided with a guide hole 12. An axial direction of the guide hole 12 is the longitudinal direction, and is on a centerline of the auxiliary device. The sliding member 12 is assembled in the guide hole 12, and the guide hole 12 is adapted to the sliding member 20. The guide hole 12 may be a through hole or a blind hole. The sliding member 20 may slide into the guide hole 12, that is, inside the supporting frame.

In some embodiments, an inner wall of the guide hole 12 is provided with a groove, and a ball 40 is arranged in the groove 40.

Specifically, the inner wall of the guide hole 12 is provided with at least one groove for accommodating the ball 40, and a plurality of balls 40 is evenly arranged in the grooves. The grooves are adapted to the balls 40, wherein a part of the ball 40 is located in the groove, and the other part of the ball 40 is exposed from the groove. During the sliding process, the sliding member 20 will contact the part of the ball 40 exposed from the groove, and make the ball 40 roll in place in the groove, such that the sliding member 20 slides along the ball 40. The purpose of arranging the ball 40 is to eliminate a frictional force between the sliding member 20 and the inner wall of the guide hole 12. The frictional force between the sliding member 20 and the guide hole 12 will hinder the synchronous vibration of the sliding member 20 and the drilling tool. The drilling tool vibrates to drive the sliding member 20 to slide, and the kinetic energy of the sliding member 20 is converted into the internal energy through the frictional force, which weakens a vibration effect of the drilling tool, such that the drilling tool cannot vibrate at a preset frequency and thus cannot achieve the effect of the vibration test.

In some embodiments, the surface of the sliding member 20 is provided with a groove, and a ball 40 is arranged in the groove.

Specifically, a surface of the sliding member 20 is provided with at least one groove for accommodating the ball 40, and a plurality of balls 40 is evenly arranged in the grooves. The groove is adapted to the ball 40, wherein a part of the ball 40 is located in the groove, and the other part of the ball 40 is exposed from the groove. The part of the ball 40 which is exposed from the groove during the sliding process of the sliding member 20 may contact the inner wall of the guide hole 12, and make the ball 40 roll in place in the groove. That is, the sliding member 20 slides on the inner wall of the guide hole 12 by using the ball 40.

In some embodiments, the groove is arranged around the axial direction of the guide hole 12, and disposed in a circumferential direction.

Specifically, the groove is arranged around the axial direction of the guide hole 12 to form an annular groove, and disposed in the circumferential direction. The bottom of the annular groove is disposed toward the axial direction of the guide hole 12. Due to the balls 40 that are evenly arranged, the sliding member 20 slides in the axial direction of the guide hole 12.

In some embodiments, the sliding member 20 is a sliding rod.

In some embodiments, a connecting member is arranged on the sliding member 20 and used for connecting with the drilling tool.

In some embodiments, a fixture 50 is arranged on the sliding member 20 and used to clamp the drilling tool.

Specifically, the fixture 50 is arranged at one end of the sliding rod away from the lifting portion, and the other end of the sliding rod extends into the guide hole 12.

In some embodiments, a holding table 50 is arranged on the connecting member and used to hold the drilling tool.

Specifically, the holding table is arranged at one end of the sliding rod away from the lifting portion, and the other end of the sliding rod extends into the guide hole 12.

In some embodiments, the elastic member 30 is a spring; and the spring sleeves the sliding member 20 and is telescopic in the longitudinal direction.

Since the spring sleeves the sliding member 20, an expansion and contraction direction of the spring is the same as a sliding direction of the sliding member 20. One end of the spring is connected to the supporting frame, and the other end of the spring is connected to the fixture 50 or the holding table, such that the spring is telescopic in the longitudinal direction.

In some embodiments, the auxiliary device further includes an alignment device (not shown), and the two auxiliary devices are located on the same vertical plane through the alignment devices.

Specifically, the alignment device is an optical sensor, which is provided with a transmitting end and a receiving end, wherein the transmitting end transmits a signal to a receiving end of another alignment device, and the receiving end receives a signal transmitted from a transmitting end of the another alignment device.

In some embodiments, the vibration device 60 includes a vibration table and a fixture, wherein the fixture is connected to the vibration table through a ball head. The vibration table is used to provide a vibration excitation. The fixture is connected between the drilling tool and the ball head (a mechanical decoupling device) for vibration transmission. The ball head is used to eliminate or reduce the influence of the mechanical coupling motion of the vibration table.

In some embodiments, the vibration device 60 further includes an alignment sensor (not shown).

Specifically, each vibration device 60 is provided with two alignment sensors, which are arranged on two opposite sides of the vibration device 60, respectively, such that centerlines of the two alignment sensors and the vibration device 60 are located on the same vertical plane. Through the alignment sensors of the two vibration devices 60 and the alignment devices of the two auxiliary devices, the centerlines of the two vibration devices 60 and the two auxiliary devices are located on the same vertical plane.

In a preferred embodiment, two vibration devices 60 are provided, and relative positions of the two vibration devices 60 should be adjustable. Compared with a vibration testing method using a single vibration device, a vibration testing method using the two vibration devices 60 has a more uniform excitation, can achieve different testing conditions, and can provide a greater thrust. The two vibration devices 60 are used for a unidirectional excitation vibration test at different positions of a test article. The two auxiliary devices are respectively arranged on two opposite sides of the two vibration devices 60, such that centerlines of the two auxiliary devices and the two vibration devices 60 are located on the same vertical plane. Bodies of the two vibration devices 60 are kept at the same height during the test.

In some embodiments, a strength safety factor of the auxiliary devices and the drilling tool should be greater than 4. A frequency of a system consisting of the auxiliary devices and the drilling tool should be lower than ⅓ of a lower limit of a designed test frequency.

Specifically, by adjusting the positions of the auxiliary devices and the vibration devices (that is, positions to hold the drilling tool by the auxiliary devices, wherein the two auxiliary devices move away from or close to each other respectively) and a force (that is, the length of the spring is changed by adjusting the height by the lifting portion, thereby changing an upward thrust on the drilling tool), a strength safety factor of the auxiliary devices and the drilling tool and a frequency of a system composed of the auxiliary devices, the drilling tool and the vibration devices is adjusted to avoid a resonance frequency of the system which is not within a designed frequency range in the test.

In some embodiments, the drilling tool vibration testing device further includes a vibration control system and a vibration measurement and analysis system. The vibration control system is used to control a vibration test according to specified test conditions to achieve an expected vibration response; and the vibration measurement and analysis system is used to collect and analyze vibration data.

The technical solution of the present application has the following beneficial technical effects.

The drilling tool is held by the two auxiliary devices, so that the weight of the drilling tool does not exceed the maximum load-bearing capacity of the vibration devices. Therefore, the vibration devices are not easily damaged, and the drilling tool is not easy to overturn in the vibration testing process. In addition, the frequency of the system consisting of the auxiliary devices, the drilling tool and the vibration devices can be adjusted by adjusting positions of the two auxiliary devices and the drilling tool, thereby avoiding a resonance frequency during the test. The present application has been described above with reference to the embodiments of the present application. However, these embodiments are for illustrative purposes only, and are not intended to limit the scope of the present application. The scope of the present application is defined by the appended claims and their equivalents. Without departing from the scope of the present application, those skilled in the art can make various substitutions and modifications, and these substitutions and modifications should all fall within the scope of the present application.

What is claimed is:

1. A double-table vibration testing device, comprising:
two auxiliary devices and two vibration devices (60), wherein
each auxiliary device comprises:
a lifting device (10) which is provided with a lifting portion (11);
a sliding member (20) which is assembled on the lifting portion (11) and slides relative to the lifting portion (11) in a longitudinal direction; and
an elastic member (30) which provides a force for the sliding member (20) to slide upward.

2. The double-table vibration testing device according to claim 1, wherein
the lifting portion (11) is provided with a guide hole (12);
an axial direction of the guide hole (12) is the longitudinal direction; and
the sliding member (20) is assembled in the guide hole (12) and slides relative to the lifting portion (11) in the longitudinal direction.

3. The double-table vibration testing device according to claim 2, wherein
an inner wall of the guide hole (12) or a surface of the sliding member (20) is provided with a groove, and a ball (40) is arranged in the groove.

4. The double-table vibration testing device according to claim 3, wherein
the groove is arranged around the axial direction of the guide hole (12), and disposed in a circumferential direction.

5. The double-table vibration testing device according to claim 1, wherein
the elastic member (30) is a spring; and
the spring sleeves the sliding member (20) and is telescopic in the longitudinal direction.

6. The double-table vibration testing device according to claim 1, wherein
the sliding member (20) is a sliding rod.

7. The double-table vibration testing device according to claim 1, wherein
a fixture (50) is arranged on the sliding member (20) and used to clamp a drilling tool.

8. The double-table vibration testing device according to claim 2, wherein
the fixture (50) is arranged on the sliding member (20) and used to clamp the drilling tool.

9. The double-table vibration testing device according to claim 3, wherein
the fixture (50) is arranged on the sliding member (20) and used to clamp the drilling tool.

10. The double-table vibration testing device according to claim 4, wherein
the fixture (50) is arranged on the sliding member (20) and used to clamp the drilling tool.

11. The double-table vibration testing device according to claim 5, wherein
the fixture (50) is arranged on the sliding member (20) and used to clamp the drilling tool.

12. The double-table vibration testing device according to claim 6, wherein
the fixture (50) is arranged on the sliding member (20) and used to clamp the drilling tool.
